(19) United States
(12) Patent Application Publication
(10) Pub. No.: US 2013/0198670 A1
(43) Pub. Date: Aug. 1, 2013

(54) ENVIRONMENT CONTROLLER PROVIDING STATE-BASED CONTROL MENUS AND ENVIRONMENT CONTROL METHOD

(71) Applicants: Charles PELLETIER, St-Jean-sur-Richelieu (CA); Dominic GAGNON, St-Bruno-de-Montarville (CA)

(72) Inventors: Charles PELLETIER, St-Jean-sur-Richelieu (CA); Dominic GAGNON, St-Bruno-de-Montarville (CA)

(21) Appl. No.: 13/740,371

(22) Filed: Jan. 14, 2013

Related U.S. Application Data
(60) Provisional application No. 61/589,373, filed on Jan. 22, 2012.
(60) Provisional application No. 61/588,900, filed on Jan. 20, 2012.

(51) Int. Cl. G06F 3/0482

(52) U.S. Cl. CPC G06F 3/0482
USPC 715/771

(57) ABSTRACT

The present disclosure relates to an environment control method and to an environment controller. An input interface receives an environmental characteristic value from a sensor. A processing module determines a current environmental state based on the environmental characteristic value. A touch-sensitive display shows an icon having a visual appearance representing the current environmental state. A user selection of the icon is detected by the touch-sensitive display. A control menu having a content based on the current environmental state is shown on the touch-sensitive display. A color or a luminance level of the icon may be used to represent the actual status. The touch-sensitive display may concurrently show several icons, each icon representing a distinct environmental feature based on one value or on a combination of values, each icon also showing a current status of the environmental feature.

### TECHNICAL FIELD

The present disclosure relates to the field of environment control systems. More specifically, the present disclosure relates to an environment controller and an environment control method in providing state-based control menus on a display.

### BACKGROUND

Systems for controlling environmental conditions, for example in buildings, are becoming increasingly sophisticated. A control system may at once control heating and cooling, monitor air quality, detect hazardous conditions such as fire, carbon monoxide release, intrusion, and the like. Such control systems therefore need to receive measured environmental values, generally from external sensors, and in turn determine set-points or command parameters to be sent to controlled devices. Parameters like these may further be reproduced in many instances: this could be the case for example when the control system controls heating and cooling in each office of a multi-storey building.

Current systems therefore allow monitoring and controlling large numbers of parameters of all kinds. These systems ly present large number of parameters, with variable value range settings, to operators, such as maintenance staff and security staff.

Controlling many parameters may become a fastidious task, requiring significant amounts of training by operators. It may become burdensome to navigate through complex menus of current control systems. Especially in case where alarms are received and present hazardous conditions, rapidly making the right choices through complex menus may become virtually impossible, especially when taking into account stress experienced by an operator.

Therefore, there is a need for facilitating user selection of parameters and parameter values on control devices.

### BRIEF DESCRIPTION OF THE DRAWINGS

Embodiments of the disclosure will be described by way of example only with reference to the accompanying drawings, in which:

FIG. 1 is a sequence diagram showing steps of an environment control method according to an embodiment;

FIG. 2 is a schematic block diagram of an environment controller according to an embodiment;

FIG. 3 is an example of a context sensitive menu with an information list;

FIG. 4 is another example of a context sensitive menu with an information list obtained by selecting an item from the menu of FIG. 3;

FIG. 5 is a perspective view of the environment controller of FIG. 2;

FIG. 6 is an example of an environment controller adapted for mounting on a panel of mechanical controlled apparatus;

FIG. 7 is an illustration of a LCD module of the environment controller of FIG. 6 mounted on a panel of a mechanical controlled apparatus;

FIG. 8 is an illustration of a LCD module of an environment controller implemented as a portable service tool;

FIG. 9 shows activating a selection wheel for an editable value;

FIG. 10 shows an example of a menu;

FIG. 11 shows an exemplary home menu;

FIG. 12 shows values and statuses of the environment controller's hardware inputs;

FIG. 13 shows an exemplary schedule menu;

FIG. 14 shows a menu with a list of events;

FIG. 15 shows a weekly schedule graphic overview screen showing current settings;

FIG. 16 shows a special event selection screen;

FIG. 17 shows a special event graphic overview screen showing the current settings;

FIG. 18 shows a menu with an override list;

FIG. 19 shows a menu with a favorite list;

FIG. 20 shows selection of a favourite;

FIG. 21 shows a menu with a Pids list;

FIG. 22 shows a Pids configuration screen;

FIG. 23 shows a menu with a trends list;

FIG. 24 shows a trends example;

FIG. 25 shows a weather screen;

FIG. 26 shows a menu with a settings list;

FIG. 27 shows an about screen;

FIGS. 28A and B shows a table describing the content of all fields;

FIG. 29 shows exemplary values and statuses of the environment controller's Values, Constants, and Variables;

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to navigation through complex menus of earlier control systems.

The following terminology is used throughout the present disclosure:

Environment: conditions prevailing in a controlled area or place, such as for example in a building.

Controller: device capable of receiving information and sending commands based at least in part on such information.

Input interface: communication device or component for receiving information or data.

Output interface: communication device or component for sending information or data.

Environmental characteristic: measurable property of an environment.

Sensor: device that detects an environment characteristic and provides a numerical representation thereof.

Processing module: processor, computer, or like device or component capable of executing mathematical or logical operations.

Environmental state: a current condition of the environment based on at least one environmental characteristic, each environmental state may comprise a range of values for one or a combination of corresponding environmental characteristics.

Touch-sensitive display: also called “touchscreen”, an electronic visual display capable of receiving commands by physical contact on its surface.

Icon: a pictorial representation of an object, a parameter, a concept.

Visual appearance: a visually distinguishable characteristic of an object, such as of an icon, text, image.

User selection: a command entered by a person, including a choice made among possible alternatives.

Control menu: a displayed list of options that may be selected.

Control menu content: each component of a displayed list of options.

Command: signal to be sent externally for acting upon to a receiving device.

Set-point value: a target value that a controlled device should reach.

State-specific control menu: a control menu whose content depends on a current state.

Independent selection of an icon: selection by a user of an icon, irrespective of other icons.

Manual input device: component of a controller for manually selecting a value.

Operably connected: directly or indirectly either electrically or wirelessly connected in a operational manner.

Memory: device or component capable of recording numerical information, such as values and states, and from which the numerical information may later be read.

The present disclosure relates to an environment control method and to an environment controller. An input interface receives an environmental characteristic value from various sensors. A processing module determines current environmental states based on the environmental characteristic values; one or several environment states may be based on one or several environmental characteristic values. A touch-sensitive display shows icons having visual appearance, for example colors, representing corresponding current environmental states. A user selection of a given icon is detected by the touch-sensitive display. A control menu having a content based on the current environmental state for the selected icon is shown on the touch-sensitive display. State-specific control menus are defined according to environmental characteristic types related to specific icons and to possible environmental states.

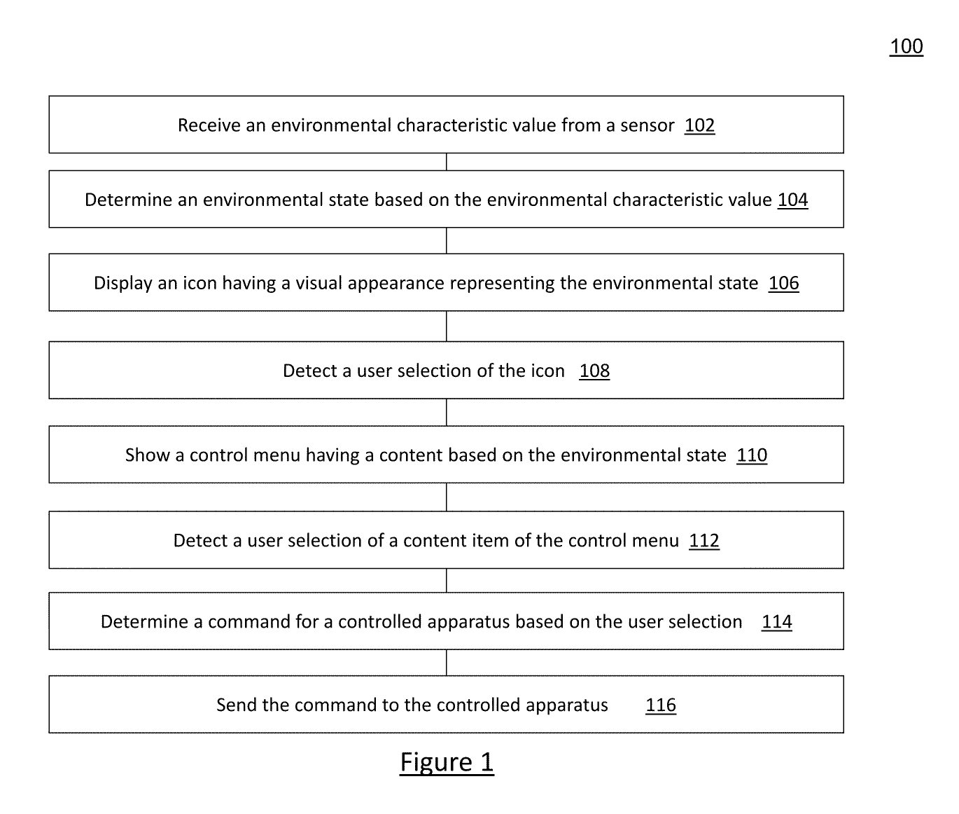

Referring now to the drawings, FIG. 1 is a sequence diagram showing steps of an environment control method according to an embodiment. A sequence 100 comprises receiving an environmental characteristic value from a sensor (102). An environmental state is determined based on the environmental characteristic value (104). An icon having a visual appearance representing the environmental state is displayed (106). Then, a user selection of the icon is detected (108). A control menu is shown (110), the control menu having a content based on the environmental state. User selection of a content item of the control menu may then be detected (112). Responsive to the user detection, a command for a controlled apparatus may be determined (114) based on the user selection of the content item of the control menu. Then, the command may be sent to the controlled apparatus (116).

The sequence 100 may be modified in numerous variants. For example, a variety of values related to several environmental characteristics may be received from several sensors. Non limiting examples of environmental characteristics may include temperature measurements, humidity measurements, air pressures, voltage measurements, on/off status for various devices, carbon monoxide detection, a flood detection, an intrusion alarm and a fire alarm. Each of these environmental characteristic values may be received in multiple instances, for example temperature values for each room of a building. As there may be a multiplicity of environmental characteristics being monitored, several environment states may then be determined. As a result, several icons may be displayed concurrently, or in alternating fashion.

Each environmental state may be based on one or more environmental characteristic values. As an example, a fire condition may be turned off when all of multiple smoke detectors provide no hazard signal, or turned on as soon as one of the smoke detectors reports a hazard condition. Commands may be sent to various types of controlled apparatus, such as fans, furnaces, air conditioning units, lighting systems, video surveillance cameras, external alarms, and the like. On/off commands may be sent to some types of controlled apparatuses while numerical set-points may be calculated and sent to other types of apparatuses. Icons may provide a pictorial representation of an environmental state, as will be illustrated in later Figures. An icon may have one color, for example green, when a normal state is present, and another color, for example red, when an abnormal condition is detected. Alternatively, an icon may be dimmed and have a low luminance when the corresponding state is normal, and a high luminance when the state is abnormal.

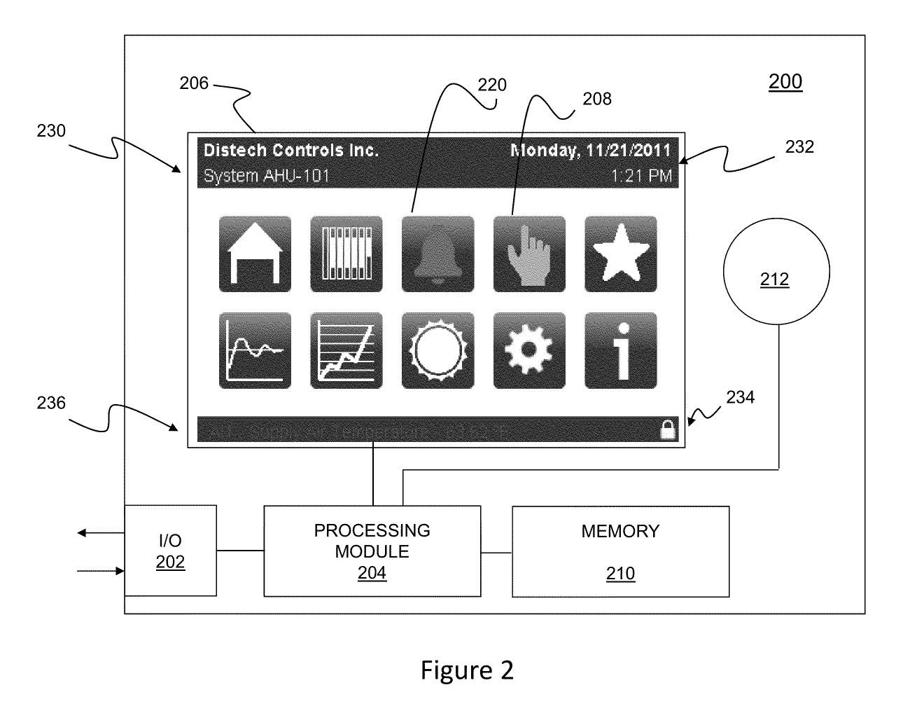

FIG. 2 is a schematic block diagram of an environment controller according to an embodiment. An environment controller 200 comprises an input interface, for example an input/output device 202, a processing module 204, a touch-sensitive display 206 and a memory 210. FIG. 2 illustrates an example of a main menu for the environment controller 200. An environmental characteristic value may be received from an external sensor (not shown) at the input/output device 202. The processing module 204 uses the environmental characteristic value to determine an environmental state. The touch-sensitive display 206 shows one or more icons, for example icon 208. The icon 208 has a visual appearance representing the environmental state. The visual appearance may comprise a color of the icon 208, which is representative of the environment state and changes when the environmental state changes. Alternatively, the visual appearance may comprise a luminance intensity of the icon representing the environmental state. The touch-sensitive display 206 may detect a user selection of the icon 208. Responsive to the user selection, the touch-sensitive display 206 may show a control menu (examples of which are shown on later Figures), the control menu having a content based on the environmental state. The touch-sensitive display 206 may detect a user selection of a content item of the control menu. Based on the user selection, the processing module 204 may then determine a command for an external controlled apparatus (not shown). The processing module 204 may then request the input/output device 202 to send the command value to the controlled apparatus. The command may for example be in the form of a set-point value for the controlled apparatus. Alternatively, the command may comprise an on/off signal for the controlled apparatus, or a trigger for an external alarm (not shown).

The environment controller 200 may be connected, via the input/output device 202, to a large number of sensors and to many controlled apparatuses. The processing module 204 may thus determine a plurality of environmental states based on a plurality of environmental characteristic values received from the sensors. Some of the environmental states may be based on more than one environmental characteristic value and a given environmental characteristic value may be used to determine several distinct environmental states. As a result, the touch-sensitive display 206 may show a plurality of icons, for example icons 208 and 220, each icon corresponding to a distinct environmental state and showing a state-specific control menu upon independent selection of a given one of the plurality of icons.

A number of icons may exceed what may readily be presented at once on the touch-sensitive display 206. A manual input device 212, for example a knob or a push-button, may connect to the touch-sensitive display 206, either directly or through the processing module 204, for selecting a subset of the plurality of icons for concurrent showing on the touch-sensitive screen 206.

Some sensors connected to the environment controller 200 may send signals providing their environmental characteristic value at time intervals, only when their value changes, or only after specific predetermined events such as when an alarm is detected. The memory 210 is operably connected to the processing module 204, for recording received environmental characteristic values. Between updates received from the sensors, the processing module 204 may determine current environmental states at least in part based on the recorded environmental characteristic values.

A plurality of environment controllers 200 may be interconnected to form an environment control network. This may be of particular interest for large environments, such as in skyscraper buildings. One such environment controller 200 may act as a master controller and may delegate monitoring of some environmental characteristics to slave environment controllers 200. Interconnection may also provide redundancy, where some environment controllers may take over the load for a failed peer controller.

In a variant, a sensor (not specifically shown), capable of being connected to the environment control network, may comprise several of the features of the environment controller 200, including a processing module that determines an environmental state based on an environmental characteristic value obtained from a sensing element of the sensor. The sensor also comprises a touch-sensitive display for showing an icon representing the environmental state and state-specific control menus, and for detecting a user selection. The sensor may, on the basis of the user selection, determine a command for a controlled apparatus and forward the command to the controlled apparatus via an output interface. The sensor may also send the environmental characteristic value or the environmental state, via the input/output interface 202, toward an environment controller connected to the environment control network. Of course, the sensor may comprise several sensing elements for measuring a variety of environmental characteristic values. The sensor may therefore determine several environment states and provide indications using several icons. A given sensor may detect similar environment characteristics at a plurality of locations while another sensor may detect various distinct environment characteristics at a same location. As a non-limiting example, a sensor may be connected to several thermocouples for measuring temperatures in several offices of a building while another sensor may be connected to a thermocouple and to a hygrometer located in a same office. Of course, other combinations of sensing elements are within the scope of the present disclosure

The environment controller 200 may also comprise a programming interface (not specifically shown), operably connected to the processing module 204, for configuring the control menu. The programming interface may be implemented using additional menus, for example drop down menus, visible on the touch sensitive screen. Alternatively, a separate programming interface (not shown) may be connected to the environment controller 200 via the input/output device 202 or via another physical or wireless interface of the environment controller 200.

Of course, the environment controller 200 is as shown is greatly simplified for ease of illustration. Those of ordinary skill in the art will readily appreciate that variants of the environment controller 200 may comprise additional components, for example a power supply, a battery backup, additional manual controls, indicator light emitting diodes (LED), additional external ports such as universal serial bus (USB), registered jacks (RJ) network interfaces, and the like. Instead of the input/output device 202, the environment controller 200 may comprise separate input and output interfaces. The environment controller 200 may further comprise brackets for mounting on a wall or on a controlled apparatus. Other variations will come to those of ordinary skill in the art having the benefit of the present disclosure.

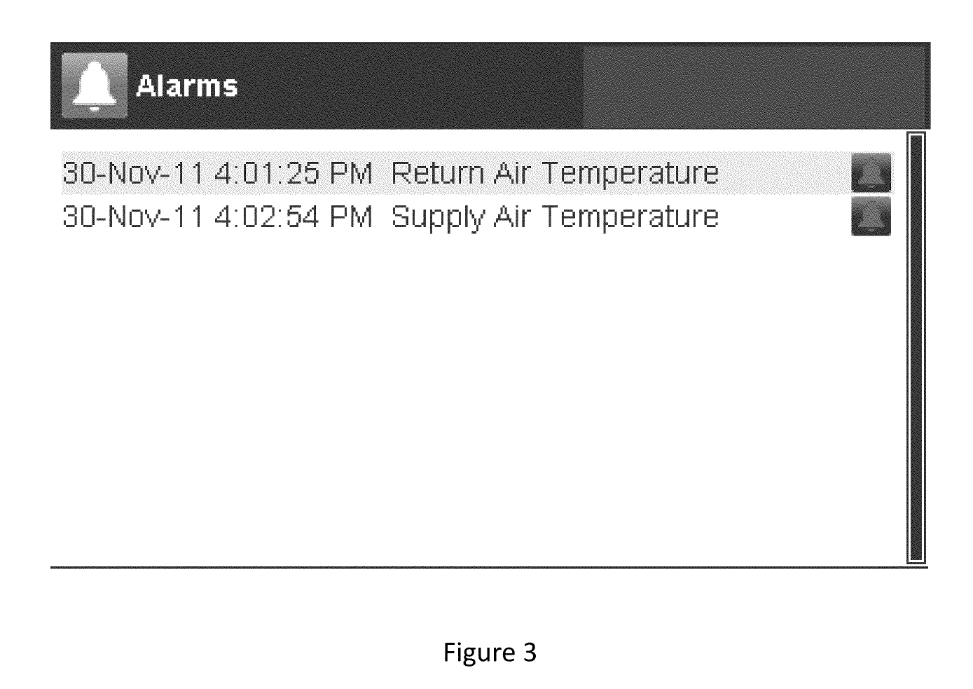

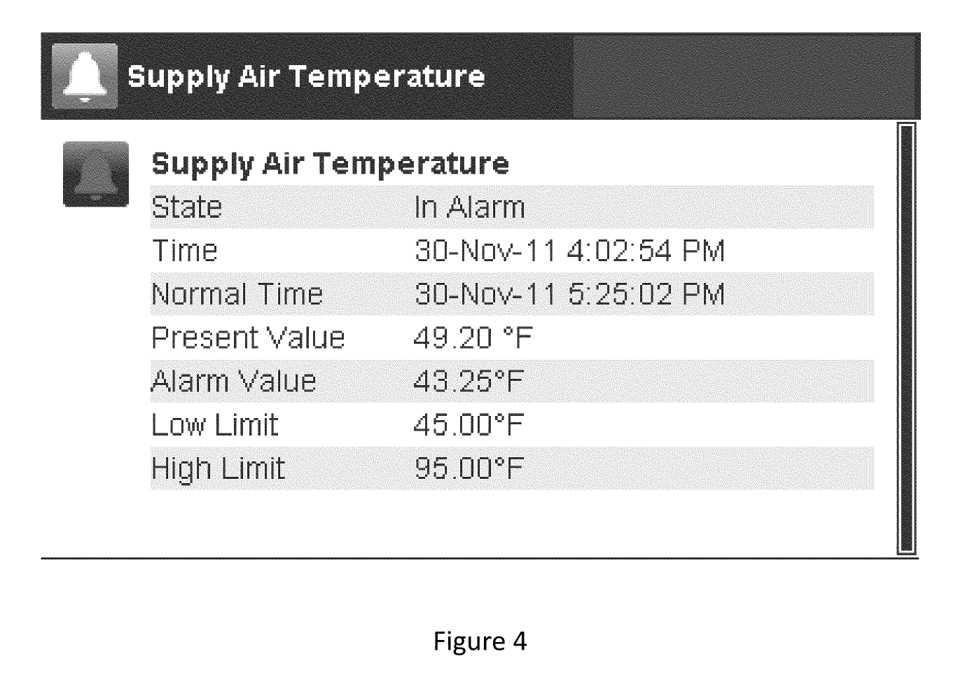

In FIG. 2, the icon 220 represents possible alarm states. FIG. 3 is an example of a context sensitive menu with an information list. Seeing that the icon 220 is highlighted, either by its color or by its luminance, a user has selected the icon 220, triggering display of the context sensitive menu with the information list of FIG. 3 on the touch-sensitive screen 206. Because the alarm state displayed using the icon 220 is based on an environmental state, which in the present example originates from temperature readings in an air conditioning system, the context sensitive menu with the information list only contains relevant information related to this alarm condition. The user may again select one of the items of the list of information of the context sensitive menu for display, on the touch-sensitive screen 206, of yet another menu. FIG. 4 is another example of a context sensitive menu with an information list obtained by selecting an item from the menu of FIG. 3. In the present example, the user has selected “Supply Air Temperature” on the menu of FIG. 3. As a result, the menu with the information list of FIG. 4 shows specific information about a supply air temperature alarm of an air conditioning system.

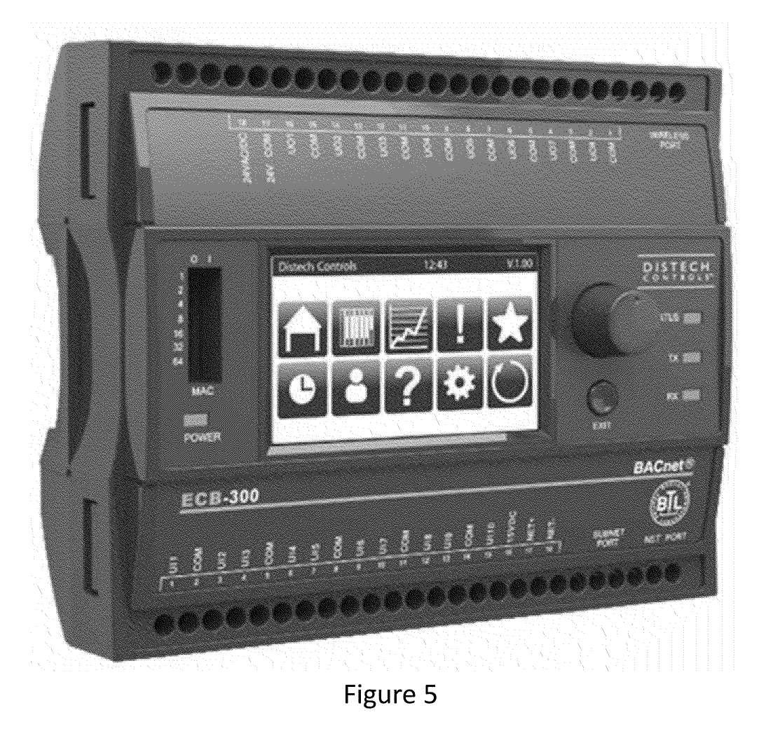

Various embodiments of the environment controller, as disclosed herein, may be envisioned. One such embodiment is illustrated in FIG. 5, which is a perspective view of the environment controller of FIG. 2. The environment controller is equipped with a color display that allows several ways to access controlled system information. The color display offers a series of features such as:

Large color display to clearly show information.

Bright display makes information easily viewable in dark mechanical rooms.

Color display provides quick information at glance such as point status such as ‘In Alarm’ or ‘In Override’.

Real-time access to monitored values, set-points, status of controlled equipment.

Alarm management and acknowledgement.

Graphical scheduler and exception days.

Trend log charts.

Multi-User access management.

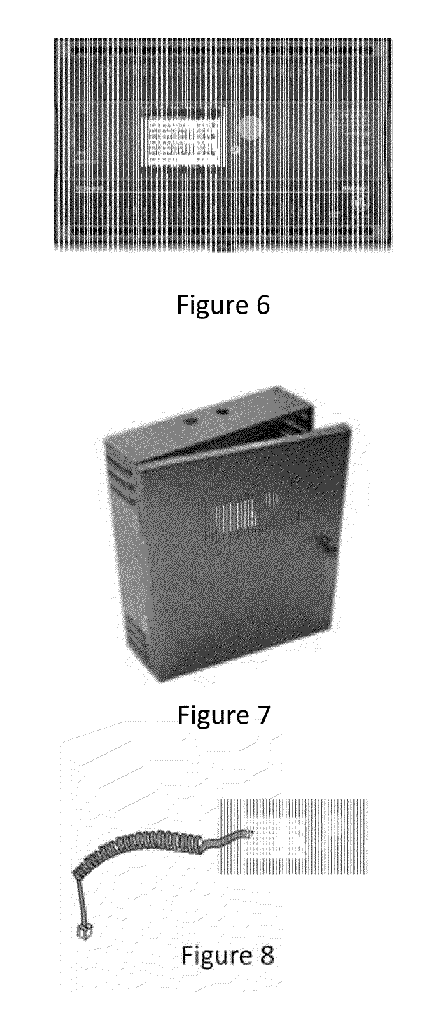

Variants of the environment controller may be present in various physical formats, as shown on FIGS. 6, 7 and 8. FIG. 6 is an example of an environment controller adapted for mounting on a panel of mechanical controlled apparatus. FIG. 7 is an illustration of a LCD module of the environment controller of FIG. 6 mounted on a panel of a mechanical controlled apparatus. FIG. 8 is an illustration of a LCD module of an environment controller implemented as a portable service tool.

Returning to FIG. 2, the touch-sensitive display 206 may show added information elements, comprising for example an operating company name 230, current date and time 232, a lock indicator 234 and a scrolling field 236 showing a preferred value.

The present disclosure reproduces below a user manual prepared for a prototype version of an environment controller according to an embodiment. The manual input device 212 of FIG. 2 may take the form of a “push and turn knob” that may be rotated to select a menu item. Pressing the push and turn knob activates a current selection. The push and turn knob may be combined with an ordinary liquid crystal display (LCD) to offer equivalent features of the touch-sensitive display 206: rather than touching the touch-sensitive display 206 to select an icon, an operator may rotate the knob to activate a selection function and navigate through the icons or through items of a menu, which are visible on the ordinary LCD. Pressing on the knob makes the selection effective. Those of ordinary skill in the art will readily appreciate that, in the following description of the prototype, presented steps for making selections using the push and turn knob may be substituted with user selections made on the touch-sensitive display 206.

The interface may be unlocked by pressing the push and turn knob to open a password menu. The password may be entered and may be changed using this menu. Pressing again the push and turn knob allows showing a main menu, similar to the menu of the touch-sensitive display 206, as seen on FIG. 2. The environmental controller 200 may return to a lock mode after a predetermined inactivity period, for example after 15 minutes.

The interface has an easy to use man-machine interface. Rotate the push and turn knob to highlight a menu item, and then press on the same knob to select the highlighted menu item. This drills-down into a submenu or toggles the highlighted menu item's selection (for example, from ENABLED to DISABLED).

A value may be set as follows:

1. Rotate the push and turn knob to select an editable value. When rolling over an editable value, a selection wheel appears.
2. Push the push and turn knob to activate the selection wheel.
3. Rotate the push and turn knob to select a value.
4. Push the push and turn knob to accept the selected value.

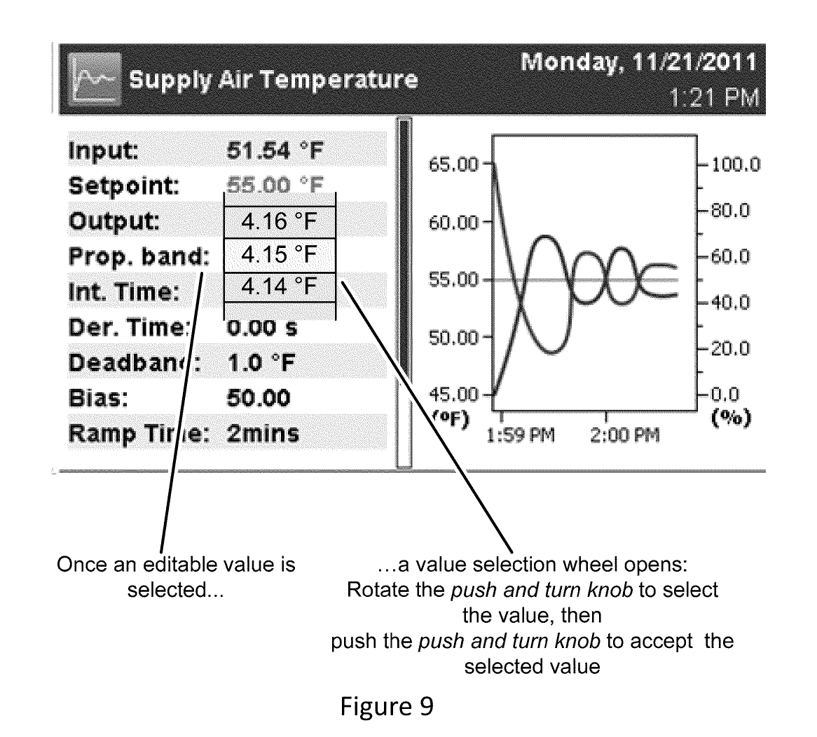

As an example, FIG. 9 shows activating a selection wheel for an editable value. Select a menu option as follows:

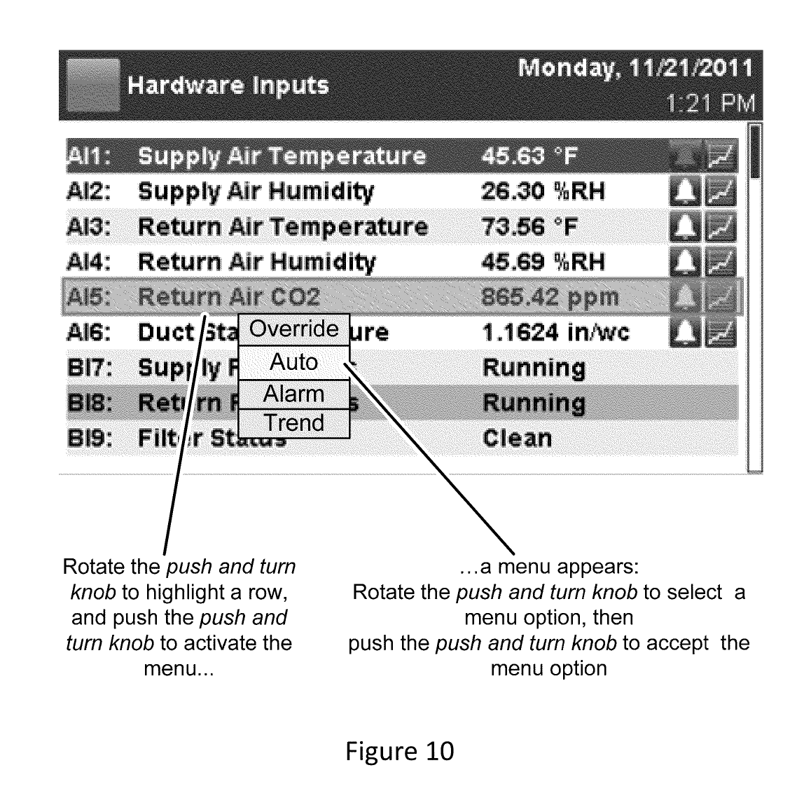

1. Rotate the push and turn knob to highlight a row and a menu appears, as shown for example on FIG. 10, which shows an example of a menu.
2. Push the push and turn knob to activate the menu.
3. Rotate the push and turn knob to select a menu option.
4. Push the push and turn knob to accept the menu option.
5. Rotate the push and turn knob to select a value.
6. Push the push and turn knob to accept the value.
7. Push EXIT to return to the previous menu.

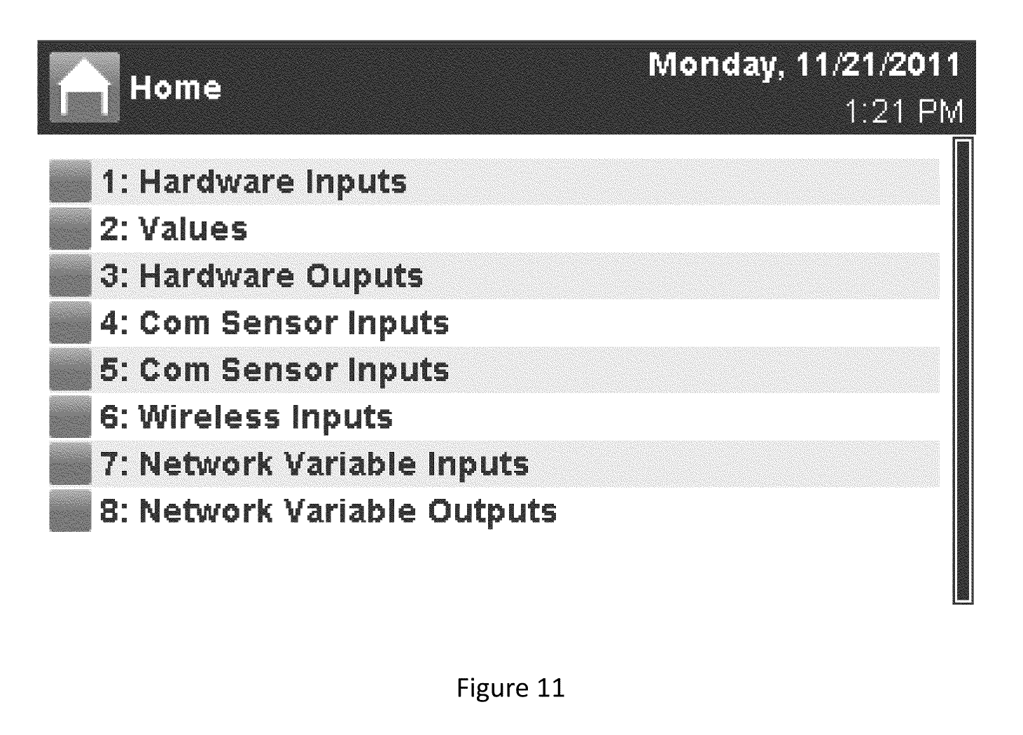

FIG. 11 shows a home menu. The home menu is used to display inputs, set points, values and output values.

When a sub-menu presents data, a color coding system is used to show the point's current status:
Alarm—red
Override—purple
Offline—yellow

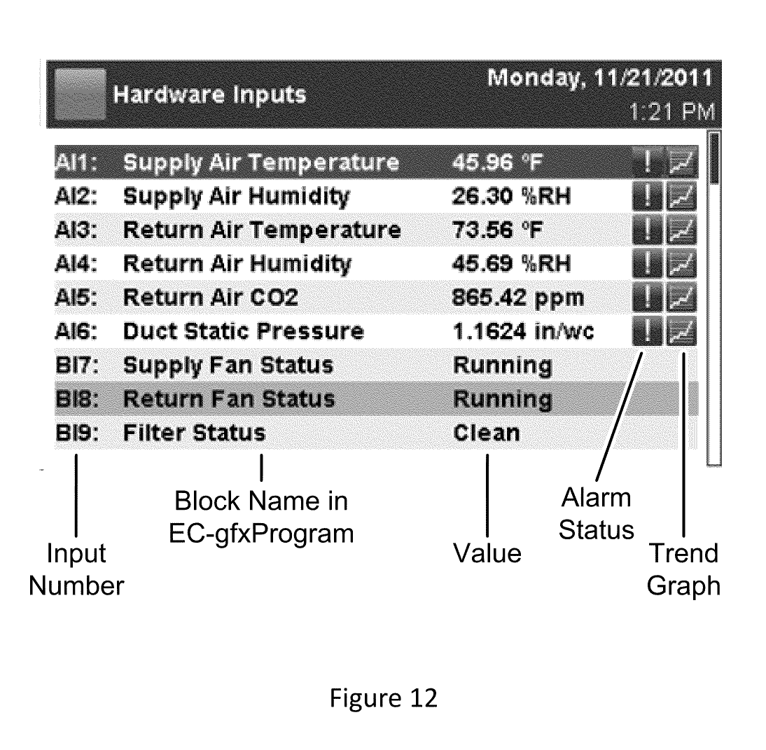

FIG. 12 shows values and statuses of the environment controller's hardware inputs. From FIG. 12, the alarm or trend screen for the associated hardware input can be displayed as follows:

1. Rotate the push and turn knob 212 to select a line with the alarm status icon or the trend graph icon.
2. Push the push and turn knob, and a pop-up menu with extra menu items is displayed corresponding to the icons shown on the selected line. For example, if the alarm status icon is on the selected line, the pop-up menu contains a “Go to alarm” menu item.
3. Push EXIT to return to the previous menu.

Input number column shows the input type configuration and the input number. Input types comprise Analog Inputs (Al) and Binary Inputs (BI).

Values and statuses of the environment controller's hardware outputs may be viewed as alarm or trend screens for the associated hardware output as follows:

1. Rotate the push and turn knob 212 to select a line with the alarm status icon or the trend graph icon.
2. Push the push and turn knob, and a pop-up menu with extra menu items is displayed corresponding to the icons shown on the selected line. For example, if the alarm status icon is on the selected line, the pop-up menu contains a “Go to alarm” menu item.
3. Push EXIT to return to the previous menu.

Various screens allow viewing values and statuses of the environment controller's sensor inputs, sensor outputs, wireless inputs, network values in, network variable inputs, network values out, and network variable outputs.

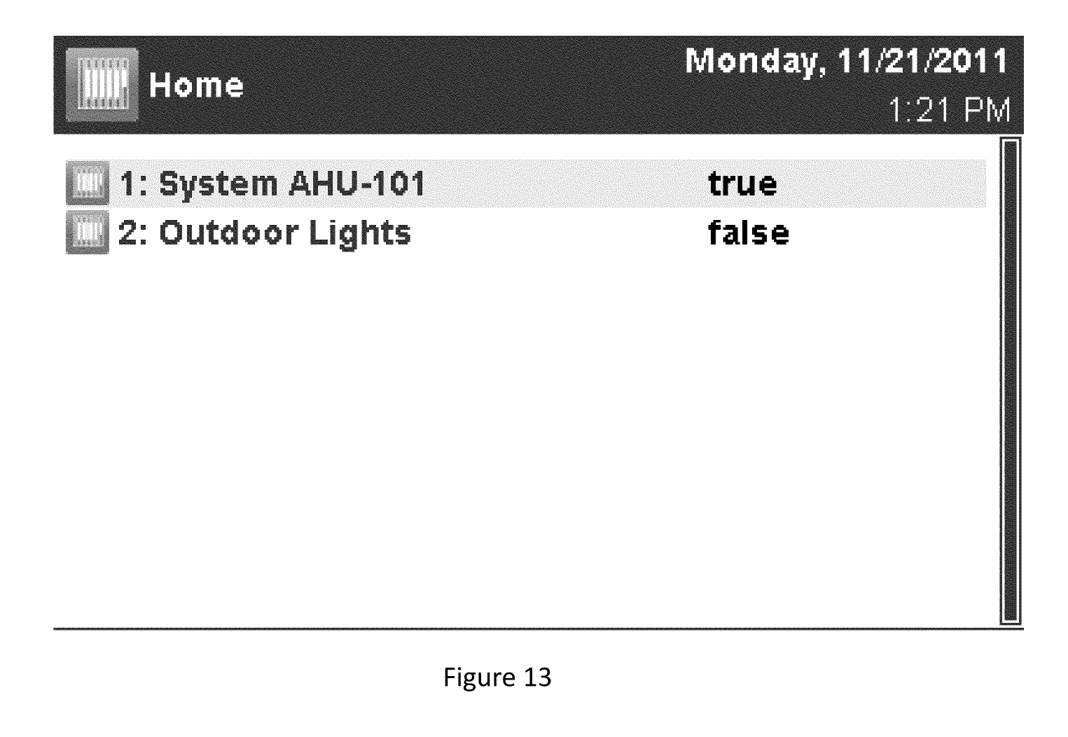

FIG. 13 shows a schedule menu. The schedule menu is used to set and adjust system schedules and calendars. Each schedule has a configuration screen according to Table I.

TABLE I

| | |
|---|---|
| Weekly | Defines the regular (repeating) |
| Schedule | day-of-week schedule events for |
| | each day of the week. See Weekly |
| | Schedule. |
| Special | Special events. override (and |
| Events | interact with) events in the normal |
| | weekly schedule. |
| Default | Defines the schedule's output |
| Output | when there is no active event. See |
| | Default Output. |

From Table I, it is possible to view and set a weekly schedule as follows:

1. Rotate the push and turn knob 212 to make a selection, as in Table II.

TABLE II

| | |
|---|---|
| Select a | Allows you to configure a |
| day of the | schedule for any individual day of |
| week | the week. |
| Select all | Allows you to configure a |
| week days | schedule for all week days, |
| | Monday to Friday. |
| Select all | Allows you to configure a |
| days of | schedule all days of the week, |
| the week | Sunday to Saturday. |

2. Push the push and turn knob 212 to accept this menu selection.
3. Rotate the push and turn knob 212 to select a menu item, as in Table III.

TABLE III

| | |
|---|---|
| Events | Create or edit the schedule for |
| | the Day of the Week, All Week |
| | Days and All Days of the Week. |
| | See Creating an Event. |
| Copy | Copies a seleoted day's schedule |
| | entry and keeps it temporarily in |
| | memory se that it can be added |
| | to another day's schedule. Use |
| | the Paste menu caption to add the |
| | copied schedule entry to the new |
| | location. |
| | This is not available for All Week |
| | Days and All Days of the Week. |
| Paste | Used in conjunction with the |
| | Copy menu option. After |
| | selecting the new location for the |
| | copied schedule entry, use the |
| | Paste menu option to place the |
| | schedule entry in the new |
| | location. |
| Clear | Deletes all schedule entries in the |
| | Day of the Week, All Week Days |
| | and All Days of the Week |
| All Day | Create an all day event. See |
| | Creating an All Day Event. |

4. Push the push and turn knob 212 to accept this menu selection.

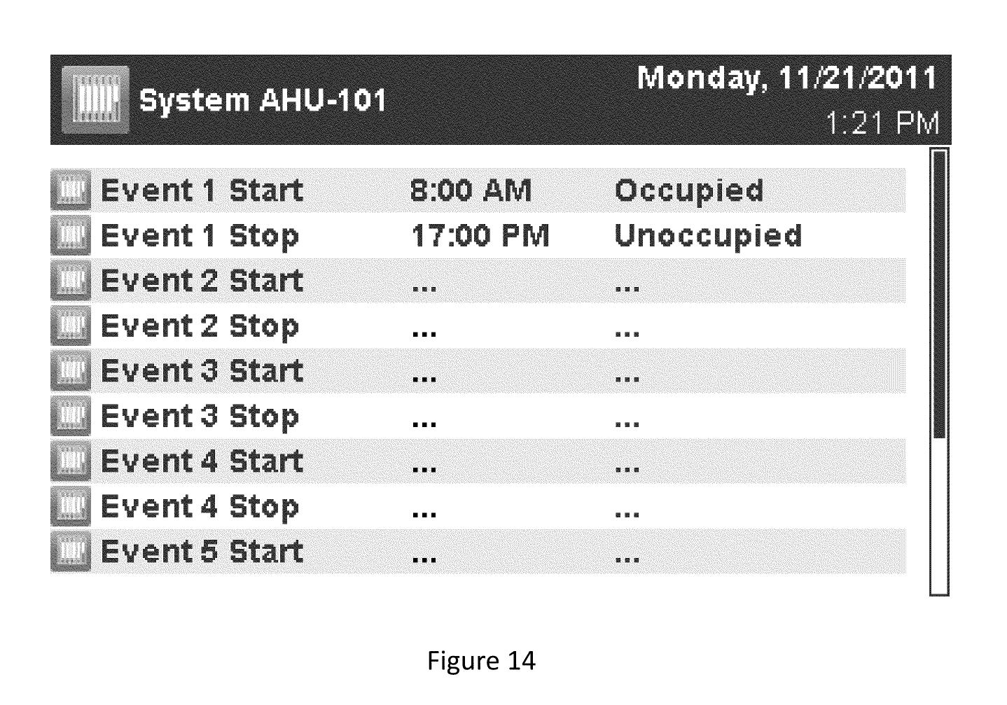

FIG. 14 shows a menu with a list of events. When Events has been selected for Day of the Week, All Week Days and All Days of the Week, create the event as follows.

1. Rotate the push and turn knob 212 to highlight an event start or stop and the menu of FIG. 14 appears, showing a weekly schedule event selection.
2. Push the push and turn knob 212 to activate the menu.
3. Rotate the push and turn knob 212 to select a value.
4. Push the push and turn knob 212 to accept the value.
5. Push EXIT to return to the previous menu.

When All Day Event has been selected for Day of the Week, create the event as follows.

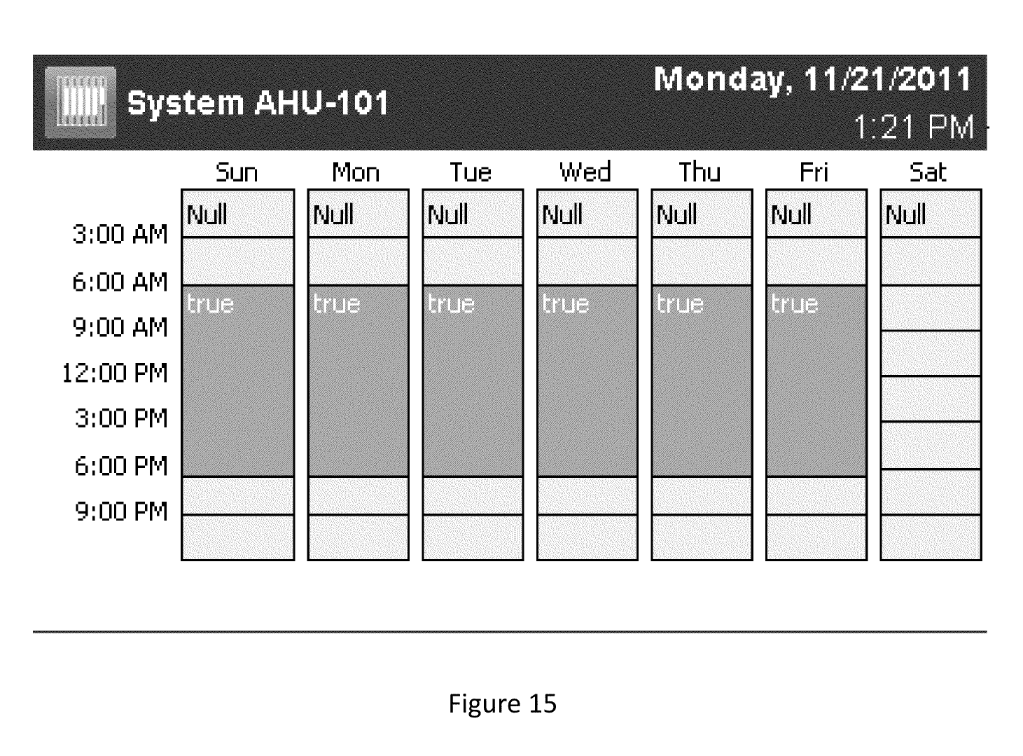

1. Rotate the push and turn knob 212 to highlight an event start or stop and a menu appears (not represented in FIG. 15).
2. Push the push and turn knob 212 to activate the menu. Rotate the push and turn knob to select a value.
3. Push the push and turn knob to accept the value.
4. Push EXIT to return to the previous menu of FIG. 15.

From the Weekly Schedule Event Selection Screen of FIG. 15, you can view and set special events as follows.

1. Rotate the push and turn knob to select a screen option as shown on Table V.

TABLE V

| | |
|---|---|
| Prev Page | Select to go to the |
| | previous page |
| Prev Month | Select to go to the |
| | previous calendar month |
| Today | Select to go to today's |
| | date |
| Next Month | Select to go to the next |
| | calendar month |
| Next Page | Select to go to the next |
| | page |
| Scroll through the | Select to go to any |
| currently shown | calendar day to |
| calendar days | configure a special event |
| | for that day. |

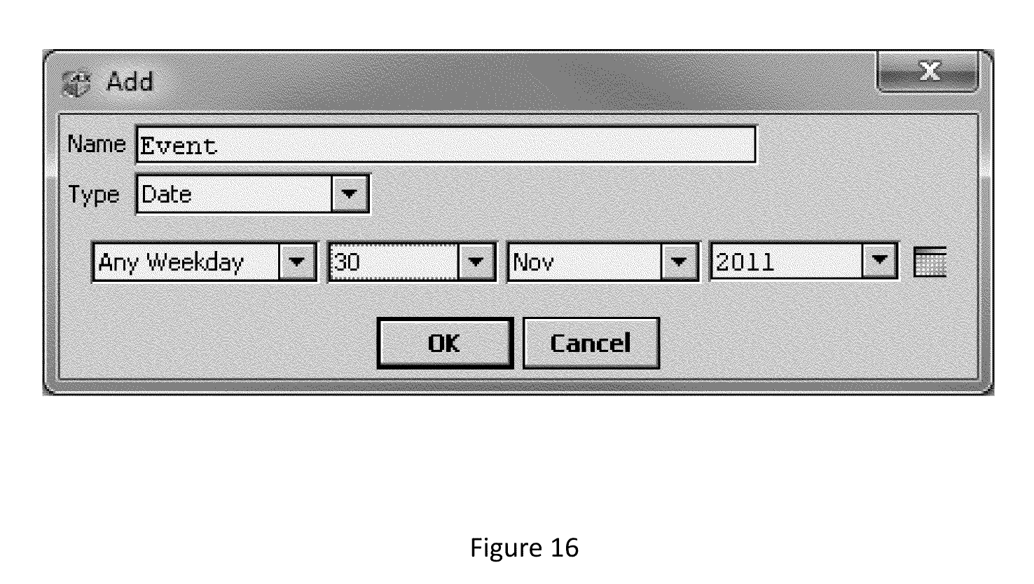

2. Push the push and turn knob to edit the schedule for that day, using a screen of FIG. 16, which shows a Special Event Selection Screen.
3. Rotate the push and turn knob to highlight an event start or stop and a menu appears.
4. Push the push and turn knob to activate the menu.
5. Rotate the push and turn knob to select a value.
6. Push the push and turn knob to accept the value.
7. Push EXIT to return to the previous menu.

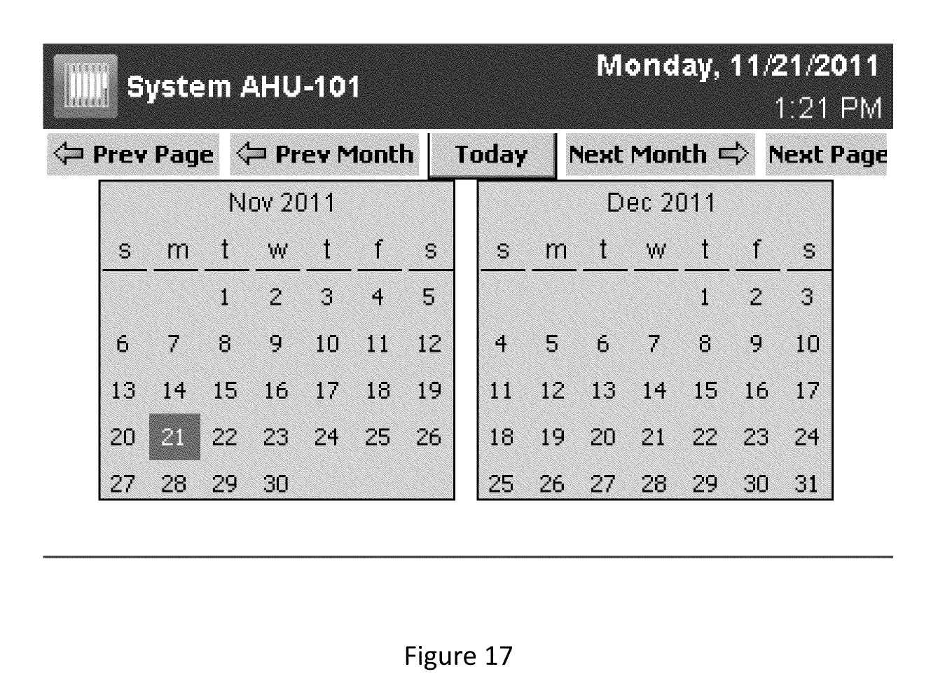

FIG. 17 shows a Special Event Graphic Overview Screen Showing the Current Settings. A default value must be configured that will be effective when there is no active event. Proceed as follows.

1. Rotate the push and turn knob to select a default value.
2. Push the push and turn knob to accept the value
3. Push EXIT to return to the previous menu.

The alarm menu shows the active alarms and the alarm history, displayed by priority, as shown on FIG. 3. Alarms can be acknowledged if the controller supports this functionality. The alarm icon will blink red when an alarm is active. The alarm icon will be steady green on a non-active alarm, that is, the alarm is yet to be acknowledged but is not currently in the alarm state. From this screen, you can view the alarm details screen for an alarm as follows:

1. Rotate the push and turn knob to select an alarm.
2. Push the push and turn knob to go to the alarm detailed information screen, as shown on FIG. 4.
3. Push EXIT to return to the previous menu.

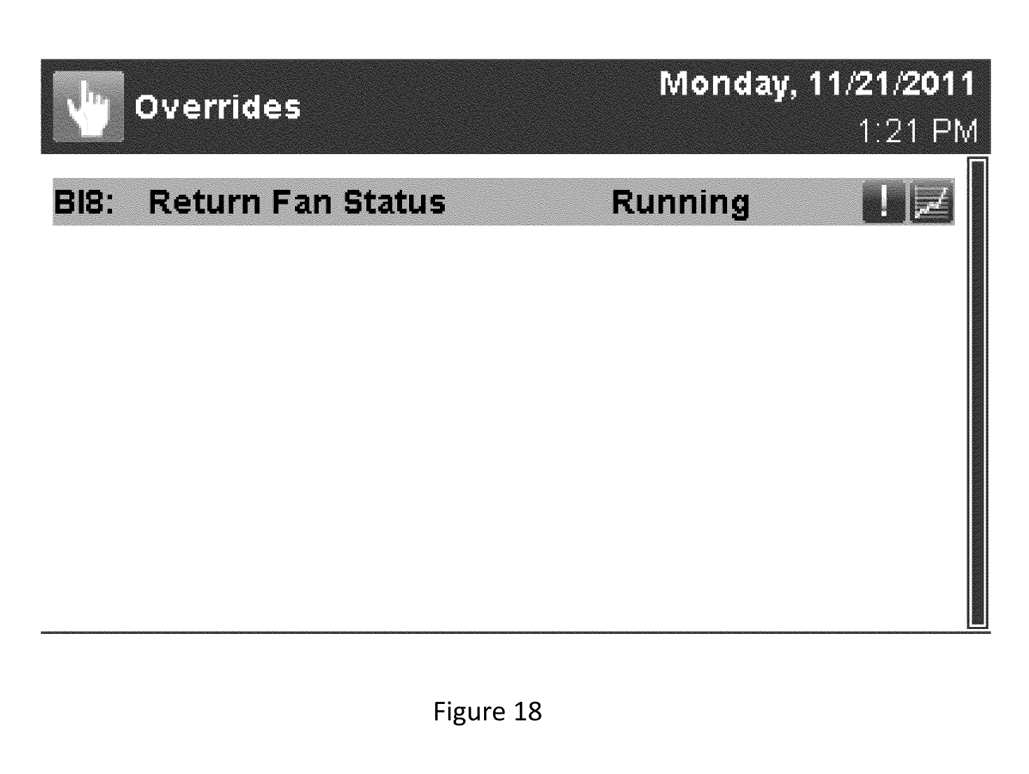

The manual overrides menu allows a user to override any hardware input, hardware output, Value, Constant, or Variable. It may be accessed via icon 240 on FIG. 2. FIG. 18 shows a menu with an override list. The first column shows the type and number, including Al or BI, as introduced earlier, Analog Output (AO) or Binary Output (BO).

From the screen of FIG. 18, you can set or view the override details screen for any hardware input, output, value, constant, or variables as follows:

1. Rotate the push and turn knob to select a hardware input, hardware output, value, constant, or variable.
2. Push the push and turn knob to go to the hardware input, hardware output, value, constant, or variable override screen.
3. Rotate the push and turn knob to select the value and push the push and turn knob to select it.
4. Rotate the push and turn knob to set the override value and push the push and turn knob to accept the value.
5. Push EXIT to return to the previous menu.

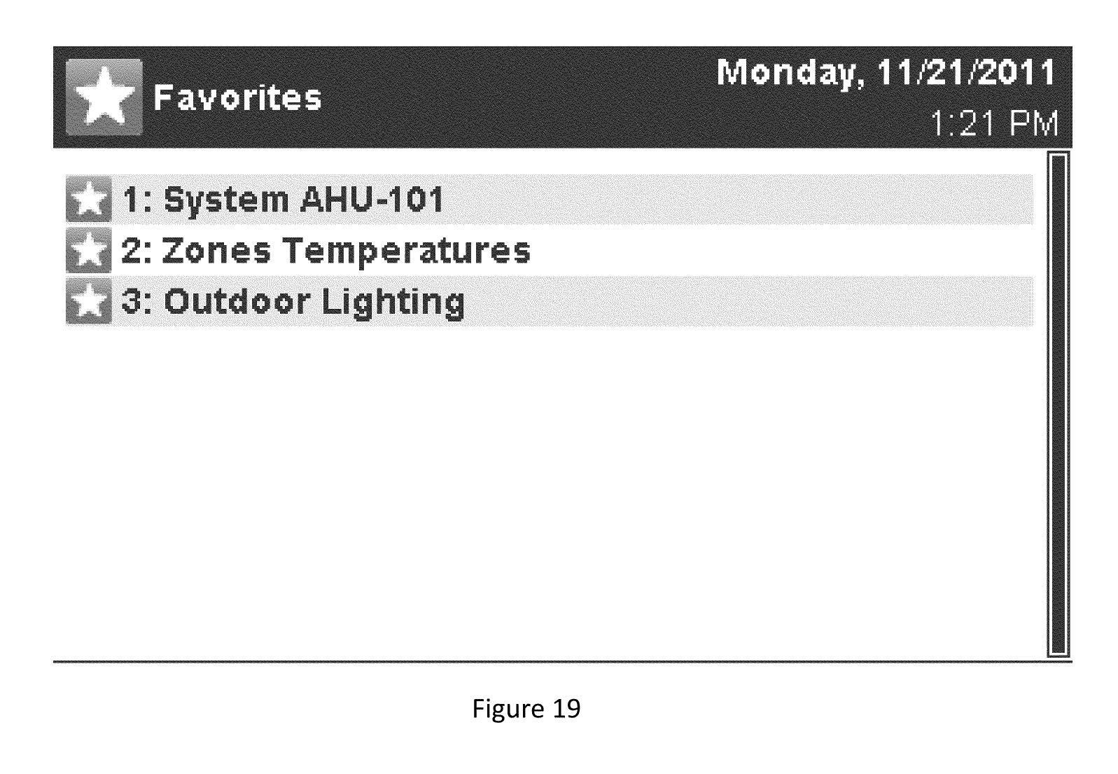

A menu with a favorite list, as shown on FIG. 19, allows the user to view a favorite screen that has been bookmarked in EC-gfxProgram. Certain menus also allow you to add the screen as a favorite.

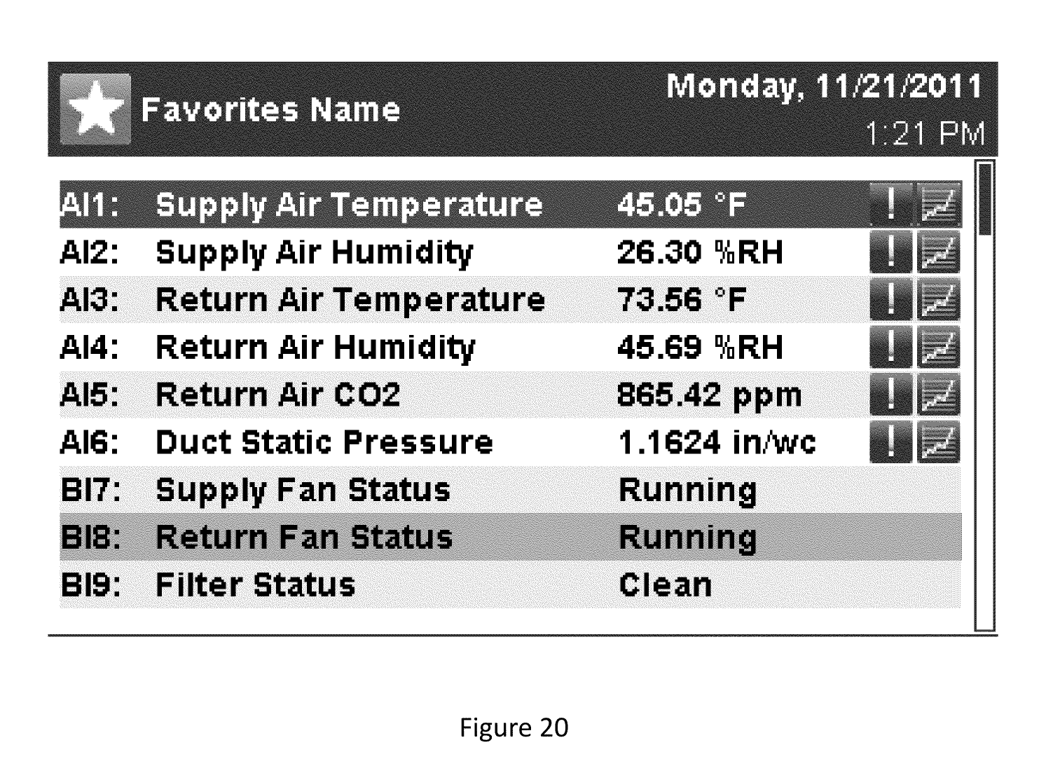

From the screen of FIG. 19, you can view a favorite as follows. FIG. 20 shows selection of a favourite.

1. Rotate the push and turn knob to select a favorite.
2. Push the push and turn knob to select the favorite.
3. Push EXIT to return to the previous menu.

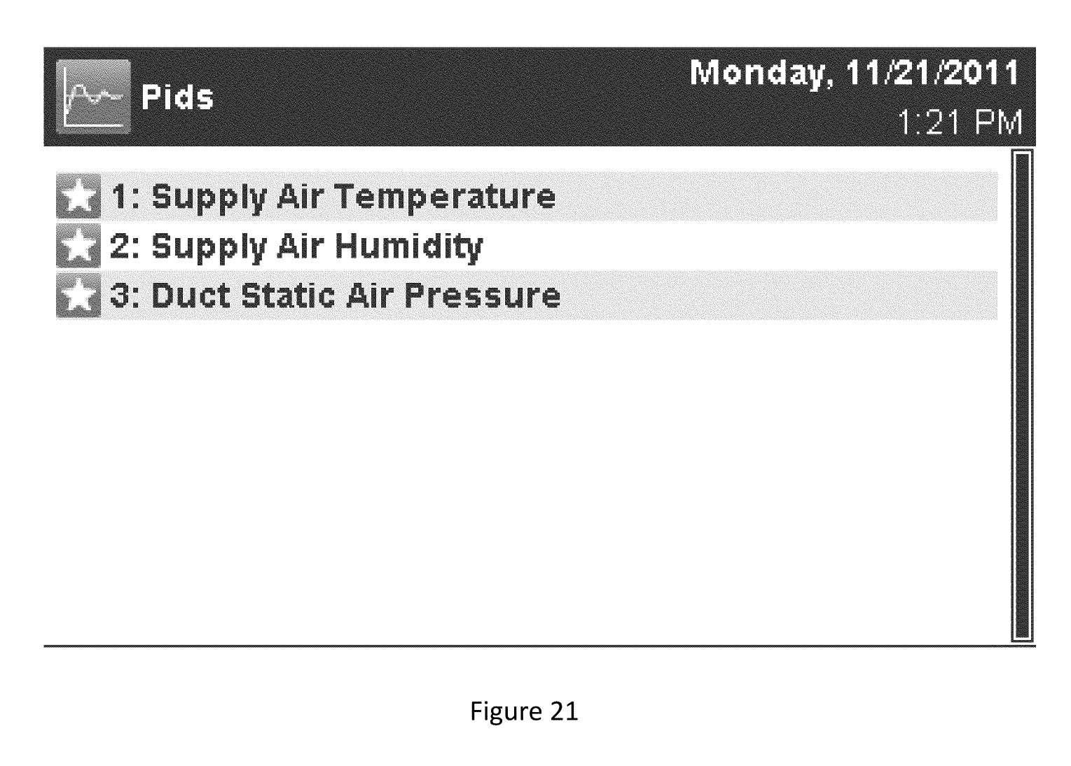

FIG. 21 shows a menu with a Pids list. The menu with the Pids list allows the user to configure the controller's PIDs. From the screen of FIG. 21, you can set or view the PID details screen as follows.

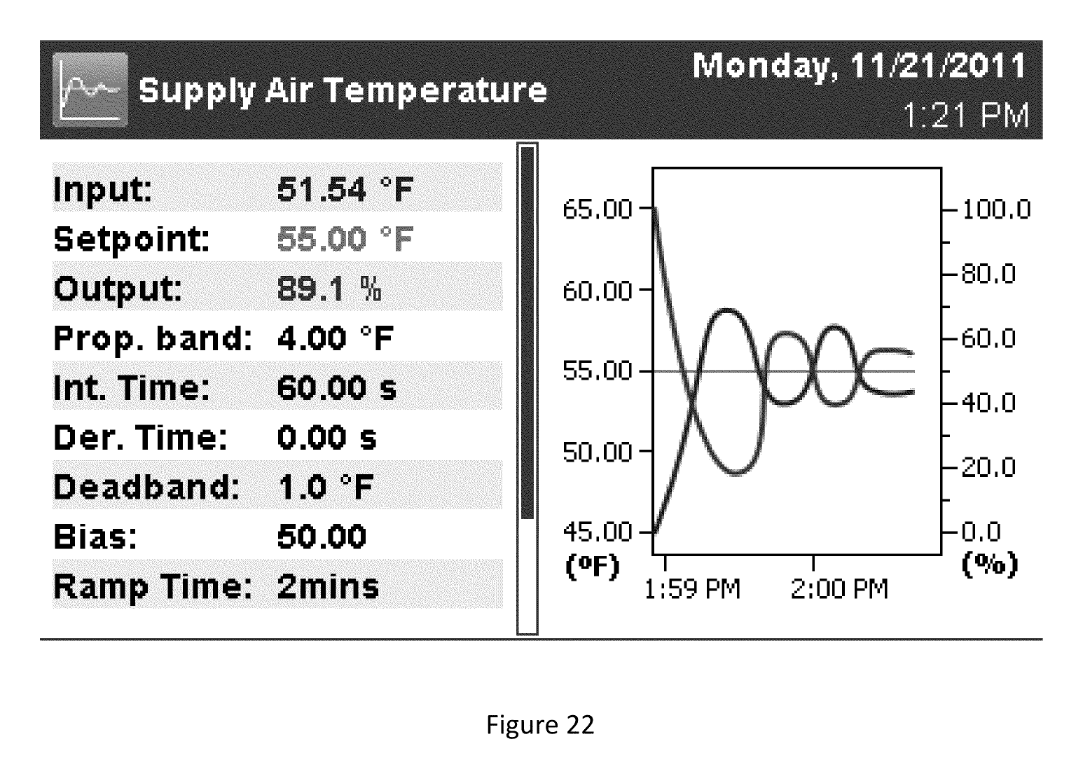

1. Rotate the push and turn knob to select a PID.
2. Push the push and turn knob to go to the PID configuration screen, as shown on FIG. 22.
Rotate the push and turn knob to select the Setpoint, Proportional Band, Integration Time, Dervative Time, Deadband, Bias, and Ramp Time and push the push and turn knob to select it.
3. Rotate the push and turn knob to set the override value and push the push and turn knob to accept the value.
4. Push EXIT to return to the previous menu.

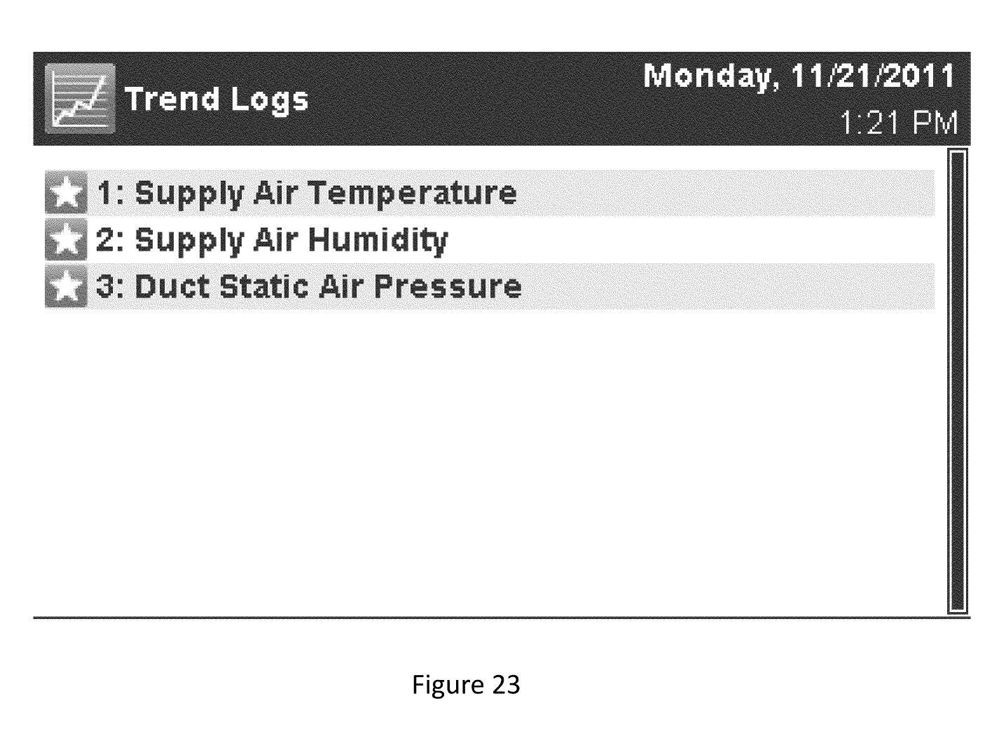

FIG. 23 shows a menu with a Trends list. The menu with the Trends list allows the user to view a value's historic trend. From the screen of FIG. 23, you can view a value's historic trend as follows.

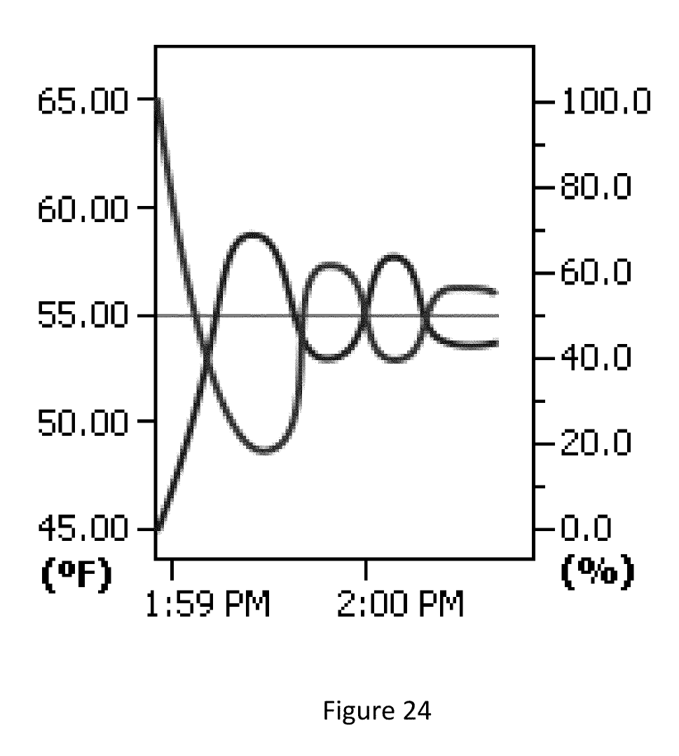

1. Rotate the push and turn knob to select a trend.
2. Push the push and turn knob to view the trend, of which FIG. 24 shows and example.
3. Rotate the push and turn knob to move along the timeline.
4. Push the push and turn knob to open a zoom selector.
5. Rotate the push and turn knob to set the amount of display zoom (or detail to be shown) and push the push and turn knob to accept the value.
6. Push EXIT to return to the previous menu.

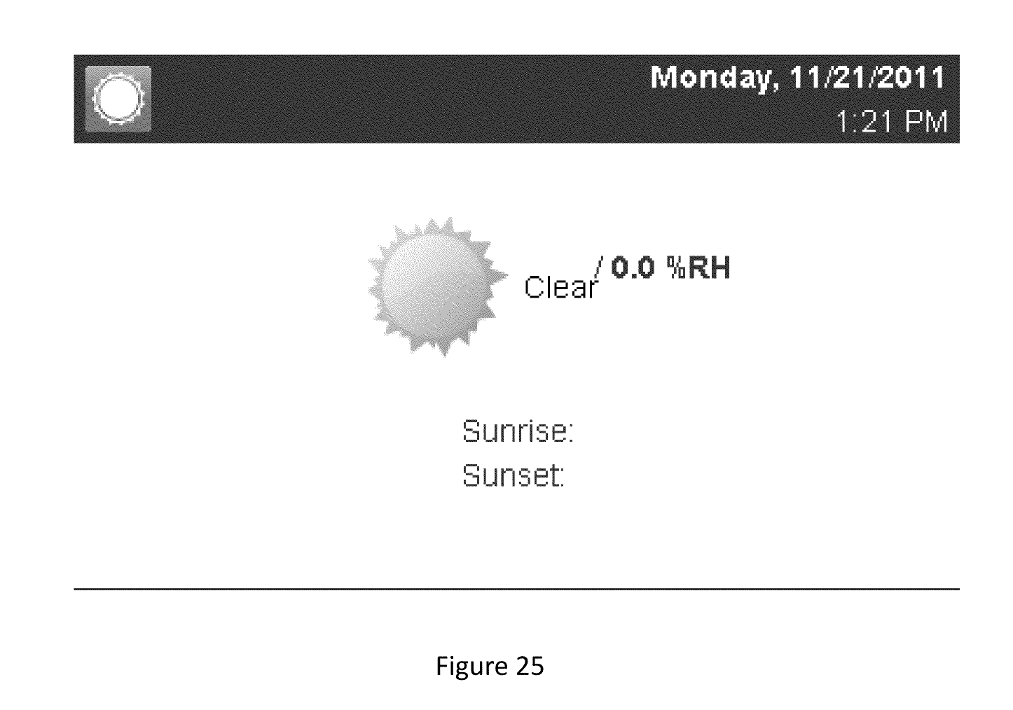

FIG. 25 shows a weather screen. The weather screen allows the user to view the current weather conditions. The units can be set to either Metric or US Units in EC-gfxProgram.

a. Current Temp
b. Current RH
c. Current Condition Image
d. Current Condition Text
e. Day Min Temp
f. Day Max Temp
g. Sunrise
h. Sunset

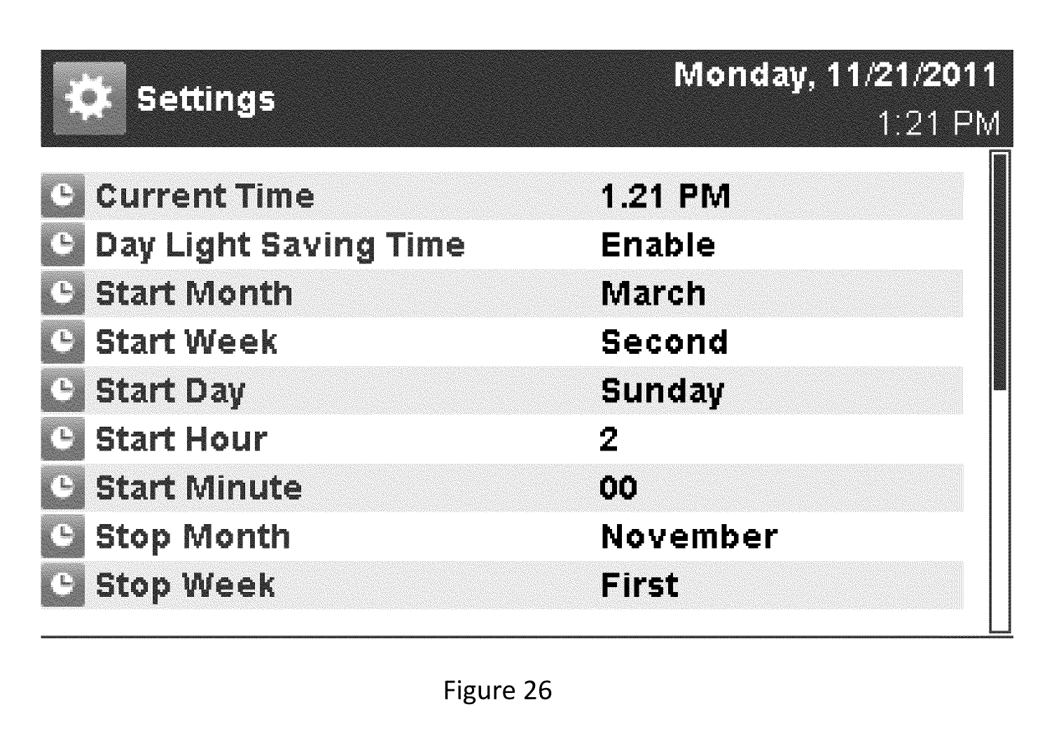

FIG. 26 shows a menu with a settings list. The menu with the settings list allows the user to view and configure the controller's settings. Table VII lists parameters that may be set with the menu with the settings list.

TABLE VII

| | |
|---|---|
| Current time | The current time |
| Day light Savings | The day light savings time |
| Time | |
| Start Month | The start month |
| Start Week | The start week |
| Start Day | The start day |
| Start Hour | The start hour |
| Start Minute | The start minute |
| Stop Month | The stop month |
| Stop week | The stop week |
| Stop Day | The stop day |
| Stop Hour | The stop hour |
| Stop Minute | The stop minute |
| Display Contrast | Sets the display's contrast according to your |
| | viewing angle. |
| Log Out Time | Sets the delay of user inactivity after which |
| | the interface becomes password protected |
| | (locked). See Unlocking the Interface. |
| MAC Address | If the controller's current MAC address is |
| | configured to 0, this allows you to set the |
| | MAC address (BACnet models only). |
| Device Instance | Sets the MAC address (BACnet models |
| | only). |
| Baud Rate | Sets the controller's Baud rate for the |
| | BACnet MS/TP network (BACnet models |
| | only). |

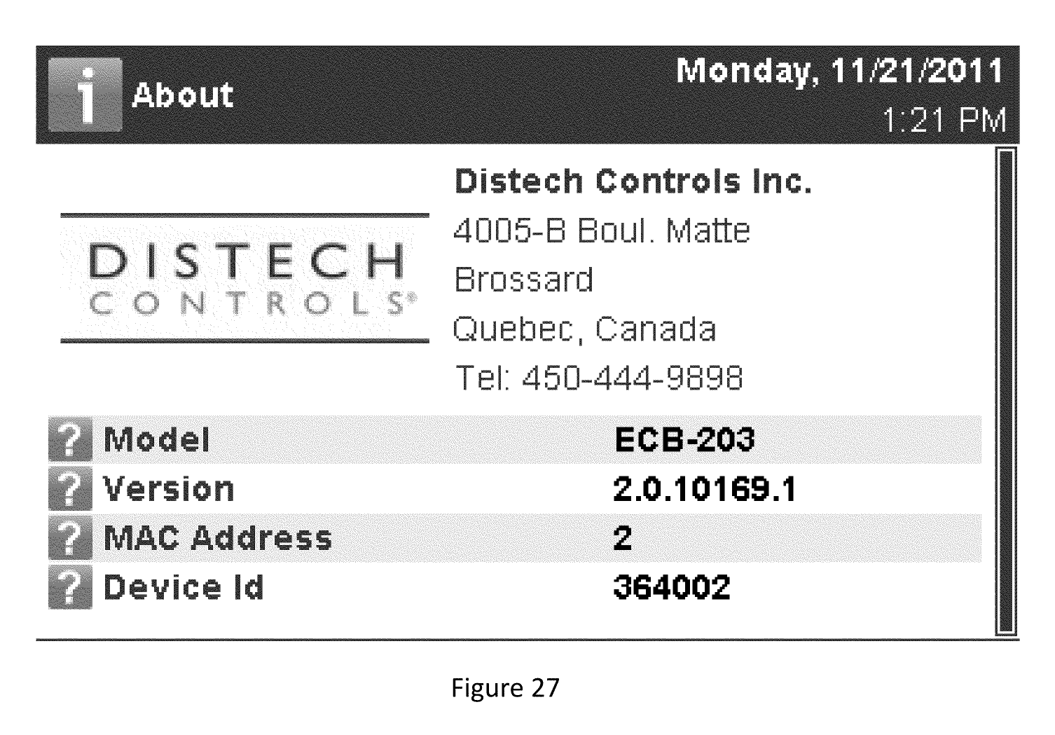

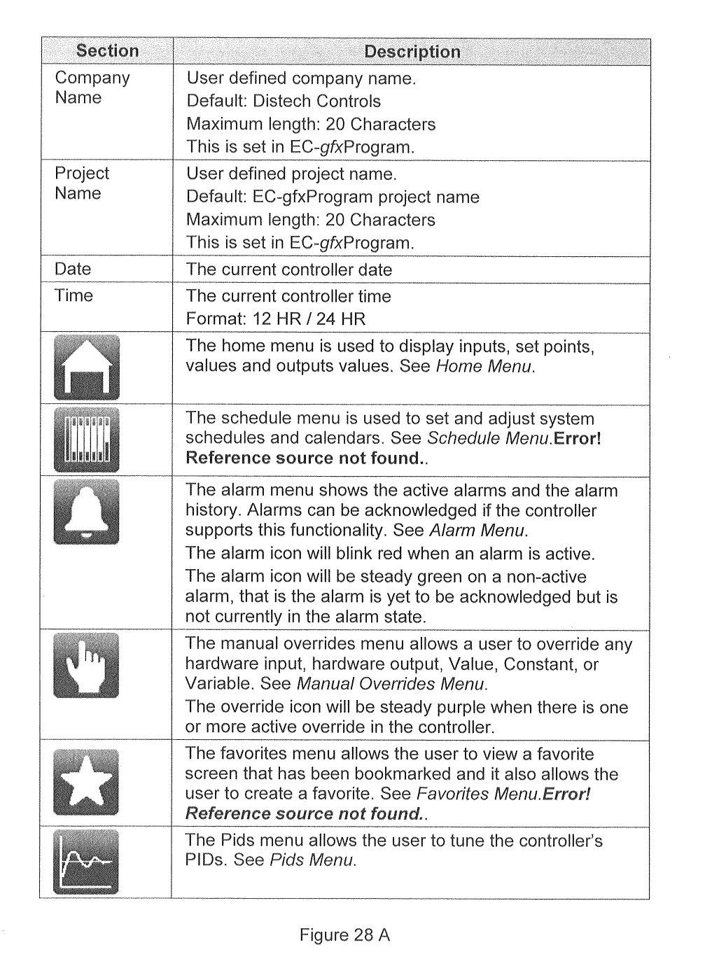

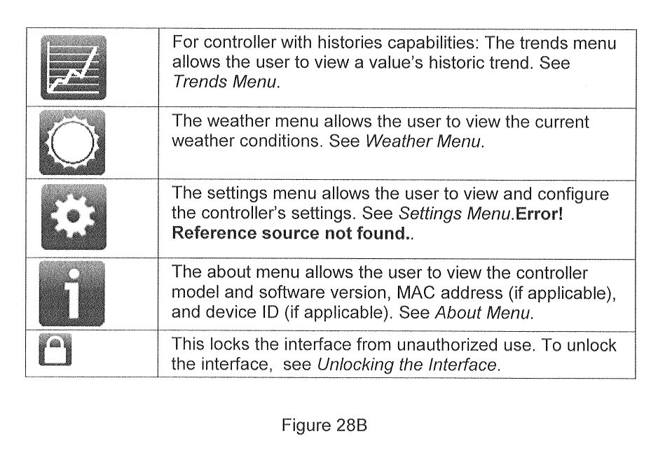

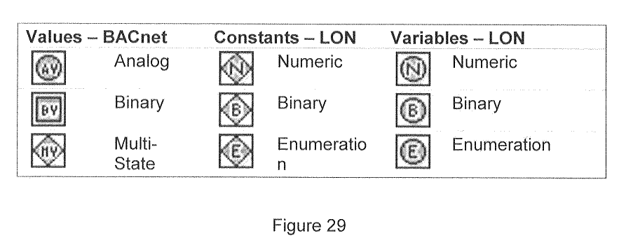

FIG. 27 shows an about screen. The about screen allows the user to view the controller model and software version, MAC address (if applicable), and device ID (if applicable). Available parameters are shown in Table VIII.

TABLE VIII

| | |
|---|---|
| Logo | Bitmap X pixels by X pixels maximum. |
| | Default graphic: Distech Controls logo. |
| | This is set in EC-gfxProgram. |
| Address line 1 | The company's name. X characters |
| | maximum. |
| | Default value: Distech Controls Inc, |
| | This is set in EC-gfxProgram. |
| Address line 2 | The company's shipping address line 1. X |
| | characters maximum. |
| | Default value: 4005-B Boul. Matte |
| | This is set in EC-gfxProgram. |
| Address line 3 | The company's shipping address line 2. X |
| | characters maximum. |
| | Default value: Brossard |
| | This is set in EC-gfxProgram. |
| Address line 4 | The company's shipping address line 3. X |
| | characters maximum. |
| | Default value: Quebec, Canada |
| | This is set in EC-gfxProgram. |
| Address line 5 | The company's shipping address line 4, X |
| | characters maximum. |
| | Default value: Tel: 450-444-9898 |
| | This is set in EC-gfxProgram, |
| Model | The controller's model number. |
| Version | The controller's firmware version number. |
| MAC Address | The controller's current MAC address |
| | number (BACnet models only). |
| Device Id | The controller's current device ID number |
| | (BACnet models only). |

Those of ordinary skill in the art will realize that the description of the environment controller and environment control method is illustrative only and is not intended to be in any way limiting. Other embodiments will readily suggest themselves to such persons with ordinary skill in the art having the benefit of the present disclosure. Furthermore, the disclosed controller and method may be customized to offer valuable solutions to existing needs and problems of environment control systems.

In the interest of clarity, not all of the routine features of the implementations of environment controller and environment control method are shown and described. It will, of course, be appreciated that in the development of any such actual implementation of the environment controller and environment control method, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of environment control systems having the benefit of the present disclosure.

In accordance with the present disclosure, the components, process steps, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of process steps is implemented by a computer or a machine and those process steps may be stored as a series of instructions readable by the machine, they may be stored on a tangible medium.

Systems and modules described herein may comprise software, firmware, hardware, or any combination(s) of software, firmware, or hardware suitable for the purposes described herein. Software and other modules may reside on servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. An environment controller, comprising:
an input interface for receiving an environmental characteristic value from a sensor;
a processing module for determining an environmental state based on at least the environmental characteristic value; and
a touch-sensitive display for:
showing an icon having a visual appearance representing the environmental state,
detecting a user selection of the icon, and
showing a control menu having a content based on the environmental state.

2. The environment controller of claim 1, wherein the visual appearance is a color of the icon representing the environmental state.

3. The environment controller of claim 1, wherein the visual appearance is a luminance intensity of the icon representing the environmental state.

4. The environment controller of claim 1, wherein:
the touch-sensitive display is capable of detecting a user selection of a content item of the control menu; and
the processing module is capable of determining a command for a controlled apparatus based on the user selection of the content item of the control menu.

5. The environment controller of claim 4, comprising an output interface for sending the command value to the controlled apparatus.

6. The environment controller of claim 4, wherein the command is a set-point value.

7. The environment controller of claim 1, wherein:
the input interface is capable of receiving environmental characteristic values from a plurality of sensors;
the processing module is capable of determining a plurality of environmental states based on the plurality of environmental characteristic values; and
the touch-sensitive display is capable of showing a plurality of icons corresponding to the plurality of environmental states, and of showing a state-specific control menu upon independent selection of a given one of the plurality of icons.

8. The environment controller of claim 7, comprising a manual input device operably connected to the touch-sensitive display for selecting a subset of the plurality of icons for concurrent showing on the touch-sensitive screen.

9. The environment controller of claim 1, comprising a memory for recording a received environmental characteristic value, wherein the processing module is capable of determining the environmental state based on the recorded environmental characteristic value between updates received from the sensor.

10. The environment controller of claim 1, comprising a programming interface, operably connected to the processing module, for configuring the control menu.

11. An environment control method, comprising:
receiving an environmental characteristic value from a sensor;
determining an environmental state based on the environmental characteristic value;
displaying an icon having a visual appearance representing the environmental state;
detecting a user selection of the icon; and
showing a control menu having a content based on the environmental state.

12. The method of claim 11, comprising:
detecting a user selection of a content item of the control menu; and
determining a command for a controlled apparatus based on the user selection of the content item of the control menu.

13. The method of claim 12, comprising sending the command to the controlled apparatus.

14. The method of claim 11, wherein the environmental characteristic value is selected from the group consisting of a temperature measurement, a humidity measurement, an air pressure, a voltage measurement, a device on/off status, a carbon monoxide detection, a flood detection, an intrusion alarm and a fire alarm.

15. A sensor, comprising:
a sensing element for measuring an environmental characteristic and for providing an environmental characteristic value;
a processing module for determining an environmental state based on the environmental characteristic value; and
a touch-sensitive display for:
showing an icon having a visual appearance representing the environmental state,
detecting a user selection of the icon, and
showing a control menu having a content based on the environmental state.

16. The sensor of claim 15, wherein the visual appearance is a color of the icon representing the environmental state.

17. The sensor of claim 15, wherein:
the touch-sensitive display is capable of detecting a user selection of a content item of the control menu; and
the processing module is capable of determining a command for a controlled apparatus based on the user selection of the content item of the control menu.

18. The sensor of claim 17, comprising an output interface for sending the command value to the controlled apparatus.

19. The sensor of claim 15, comprising an output interface for sending the environmental characteristic value toward an environment controller.

20. The sensor of claim 15, comprising an output interface for sending the environmental state toward an environment controller.
